(19) United States
(12) Patent Application Publication
(10) Pub. No.: US 2014/0278531 A1
(43) Pub. Date: Sep. 18, 2014

(54) AUTOMATED REFILL REQUEST PROCESSING SYSTEM AND METHOD

(71) Applicant: HEALTHFINCH, INC., Madison, WI (US)

(72) Inventor: Ash Gupta, Madison, WI (US)

(73) Assignee: HEALTHFINCH, INC., Madison, WI (US)

(21) Appl. No.: 13/838,304

(22) Filed: Mar. 15, 2013

(51) Int. Cl. G06F 19/00

(52) U.S. Cl. CPC G06F 19/3456
USPC 705/3; 705/2

(57) ABSTRACT

Automated processing of medication refill requests is provided. A medication refill request is received, and the refill request is parsed to obtain the refill information contained in the refill request. The refill information is used to determine whether to authorize the refill request. Determining whether to authorize the refill request includes determining whether supplemental information used to authorize the refill request is available. If the supplemental information is not available, a notification is provided indicating the supplemental information is not available and a timeout period is set. Processing of the refill request continues when the supplemental becomes available before the timeout period expires. If the timeout period expires before the supplemental information becomes available, then the refill request is discarded.

### TECHNICAL FIELD

Aspects of the invention generally relate to electronic medical record (EMR) systems. In particular, various aspects of the invention include an approach to automatically processing medication refill requests.

### BACKGROUND

Health care providers continue to adopt the use of electronic medical records to assist in the provision of health care to patients. EMR systems can streamline many of the tasks involved in providing health care to patients.

One task for which health care providers may utilize EMR systems is the prescription of medications and authorizing renewal of those prescriptions. Sometimes referred to as electronic prescribing, health care providers may utilize EMR systems to transmit electronic prescription or renewal authorizations to pharmacies for fulfillment. Electronic prescribing has been known to improve the accuracy and the efficiency of the prescription and renewal process.

Before a health care provider transmits a renewal authorization, however, the health care provider must determine whether the medication can or should be refilled. Determining whether to authorize a refill request can be a time-consuming process that may involve matching the requested medication against a medication list for the patient and verifying that the refill request includes the information necessary to authorize the refill request.

Health care providers may receive hundreds of renewal requests per day. As a result, health care providers may spend significant amounts of time and effort reviewing refill requests and determining whether to authorize those refill requests.

While attempts have been made to adapt EMR systems to process refill requests, there remains room for improvement.

### BRIEF SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

A computer-implemented method of processing medication refill requests is provided. A medication refill request is received, and the refill request is parsed to obtain the refill information contained in the refill request. The refill information is used to determine whether to authorize the refill request. The refill information contained in the refill request may be normalized such that normalized refill information is also used to determine whether to authorize the refill request. Determining whether to authorize the refill request includes determining whether supplemental information used to authorize the refill request is available. If the supplemental information is not available, a notification is provided indicating that the supplemental information is not available. Additionally, a timeout period is set, and processing of the refill request continues when the supplemental becomes available before the timeout period expires. If the timeout period expires before the supplemental information becomes available, then the refill request is discarded.

Discarding the refill request may include sending the refill request to a review pool. A refill request may also be sent to a review pool in response to a determination that the refill request is a duplicate refill request or when the refill request cannot be validated. Validating the refill request may include determining whether a patient associated with the refill request is a current patient of a health care provider that received the refill request, determining whether the medication requested in the refill request is a current medication of the patient, and determining whether the medication requested is a discontinued medication.

A system for processing medication refill requests is also provided. The system includes an integration module that is in signal communication with an electronic medical record system and a refill request processing module in signal communication with the integration module. The integration module receives refill requests from the EMR system, and the refill request processing module determines whether to authorize the refill request in accordance with the steps set forth above. The system may also include one or more review pools that include refill requests the refill request processing module could not authorize. Review pools may include a supplemental information review pool, an invalid refill request review pool, and a duplicate refill request review pool.

Aspects of the invention may also be embodied in a non-transitory computer readable storage medium having computer-executable program instructions stored thereon. The instructions, when executed by a processor, cause the processor to perform the steps for processing medication refill requests set forth above.

### BRIEF DESCRIPTION OF THE DRAWINGS

The present invention is illustrated by way of example and is not limited in the accompanying figures in which like reference numerals indicate similar elements.

FIG. 1 is an example of an implementation of a refill request processing system.

FIG. 2 is a flowchart of example method steps for automatically processing a refill request.

FIG. 3 is a flowchart of example method steps for automatically validating a refill request.

### DETAILED DESCRIPTION

As noted above, improved approaches to processing refill requests at EMR systems are needed. The refill request processing system described in this disclosure automates the refill request processing procedure as much as possible so as to minimize the involvement of health care providers. A health care provider (“provider”) may be a doctor, nurse, or other health care provider that receives medication refill requests. A refill request refers to a notification that a patient desires renewal of a medication prescription. Accordingly, the patient may provide the refill request via phone message, facsimile message, email message, or another form of communication. A refill request may also refer to an automated notification from an EMR system. The EMR system may automatically generate the refill request in response to a determination that a medication prescription for a patient is about to expire.

Upon successful processing of the refill request, the refill request processing system may provide notification to the health care provider indicating the refill request is authorized. The health care provider may receive the authorization notification, for example, at the EMR system. In response to receipt of the notification, the health care provider may transmit the refill authorization to a pharmacy for fulfillment. In some example implementations, the refill request processing system itself may automatically transmit the authorization to the pharmacy for fulfillment.

The refill request processing system may process a refill request in accordance with a set of protocols provided by a provider. Providers may supply the refill request processing system with unique sets of protocols such that refill requests are processed according to provider-specific guidelines. If the protocols indicate that further action is needed before the refill request can be authorized, the refill request processing system delegates a task to a responsible individual. In this way, the refill processing system advantageously leverages the efforts of a clinical support team—e.g., doctors, nurses, clinic staff, automated systems, and patients—to further the progress of refill request process rather than having a single individual or set of individuals responsible for processing refill requests as may be done in conventional practice.

In some circumstances, for example, the refill request processing system may not be able to automatically authorize a refill request. In some situations, for example, the refill request management system may determine that the health care provider should review the refill request or that additional information is needed before the refill request processing system can determine whether to authorize the refill request. The additional information may be, for example, lab test results, medical history information, and the like.

In these situations, the refill request processing system may provide notification to the health care provider that indicates the refill request could not be authorized. The refill request processing system may, for example, transmit a message to the EMR system utilized by the health care provider. The message may indicate reason review is needed or may identify the additional information needed before the refill request can be authorized.

Accordingly, the refill request processing system automatically authorizes refill requests whenever possible and notifies providers of refill requests that cannot be automatically authorized. For refill requests that cannot be automatically authorized, health care providers may manually review these refill requests and determine how to proceed. In this way, the refill request processing system advantageously minimizes the involvement of health care providers in reviewing, processing, and authorizing refill requests. Additional advantages will be apparent with the benefit of the disclosures below.

Referring to FIG. 1, an example of an implementation of a refill request management system 100 is shown. As seen in FIG. 1, the example refill request processing system 100 includes a refill request processing module 102 that processes refill requests from one or more electronic medical records 104 of one or more EMR systems 106. The refill request processing module 102 may be in signal communication with one or more integration modules 108 that assist with the processing of refill requests. As discussed further below, the integration modules 108 may validate refill requests and normalize refill information contained in the refill request to obtain normalized refill information. Accordingly, one or more integration modules 108 may be in respective signal communication with the one or more EMR systems 106. The refill request processing module 102 may also be in signal communication with a data storage module 110 that stores refill protocol information, i.e., a refill protocol repository.

Furthermore, the refill request processing module 102 and one or more of the integration modules 108 may be in signal communication with one or more review pools 112. The review pools 112 may represent lists of refill requests that the refill request processing system 100 could not automatically authorize. As discussed further below, the refill request processing module 102 may discard a refill request if the refill request processing module 102 cannot automatically authorize the refill request. Discarding the refill request may include sending the refill request to one of the review pools 112 for manual processing by a health care provider. As seen in FIG. 1, the refill request processing system 100 may include multiple review pools 112. Each review pool may be dedicated to listing refill requests that could not be authorized for a particular reason, e.g., an invalid refill request review pool for refill requests that cannot be validated, a duplicate refill request review pool for duplicate refill requests, and supplemental information review pool for refill requests needing supplemental information before authorization. Review pools 112 will be discussed in further detail below. The refill request processing system 100 thus employs the review pools 112 to notify health care providers when a refill request cannot be automatically authorized. In this way, relatively more refill requests may be processed than otherwise would be.

The review pools 112 may be implemented, for example, as message lists in the EMR systems 106 utilized by the health care providers. The refill requests listed in the review pools 112 may be stored at a data storage device such as, for example, a database in one or more records of one or more database tables. Additional or alternative approaches may be selectively employed to implement the review pools 112.

Similarly, the refill protocols may also be stored at one or more data storage devices. In this regard, the refill protocol repository 110 may be, for example, a database that stores the refill protocols in respective records of one or more database tables.

The integration module 108 and refill request processing module 102 may be selectively implemented as a service or application running at one or more local computing devices or running at one or more remote computing devices. The integration module 108 and refill request processing module 102 may be implemented, for example, as a plug-in, add-on, extension of, custom function, or the like in an EMR system 106. The integration module 102 and refill request processing module 102 may, additionally or alternatively, be implemented as a service or application running at a local computing device in signal communication with the EMR system 106 or as web client or web service in signal communication with the EMR system 106 and accessible over a computer network 114 such as the Internet. In sum, the integration module 108 and the refill request processing module 102 may be any suitable server, processor, computer, or data processing device, or combination of the same.

The refill request processing module 102 may be in signal communication with an integration module 108 directly or via a computer network 114 as shown by way of example in FIG. 1. The computer network 114 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. One or more communication links may interconnect the refill request processing module 102, the integration module 108, and the refill protocol repository 110. The communications links may be any communications links suitable for communicating between the components of the refill request processing system 100, such as network links, dial-up links, wireless links, hard-wired links, and the like. It will be understood that additional or alternative implementations and configurations for the refill request processing system 100 may be selectively employed.

The disclosure is operational with numerous other general purpose or special purpose computing system environments or configurations. Examples of well-known computing systems, environments, or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like. The integration module 108 or refill request processing module 102 may also be mobile terminals, such as smart phones, personal digital assistants (PDAs), and the like, which may include various other components, such as a battery, speaker, and antennas

The computing devices may include components (not shown) for controlling the overall operation of the integration module 108 or refill management module 102, including one or more processors, RAM, ROM, other storage devices, and an input/output (I/O) module. The I/O module may include a microphone, keypad, touch screen, or stylus through which a user of the computing device may provide input, and may also include one or more of a speaker for providing audio output and a video display device for providing textual, audiovisual or graphical output. Software may be stored within the memory or other storage devices to provide instructions to the processor for enabling the computing device to perform various functions. For example, the memory may store software used by the computing device, such as an operating system, application programs, and an associated database. The processor and its associated components may allow the computing device to run a series of computer-readable instructions to automatically process refill requests.

The disclosure may be described in the general context of computer-executable instructions, such as program modules, being executed by a computer. Generally, program modules include routines, programs, objects, components, data structures, and the like that perform particular tasks or implement particular abstract data types. The disclosure may also be practiced in distributed computing environments where tasks are performed by remote processing devices that are linked, for example, through a communications network. In a distributed computing environment, program modules may be located in both local and remote non-transitory computer storage media including memory storage devices.

The computing device may operate in a networked environment supporting connections to one or more remote computers such as personal computers or servers that include many or all of the elements described above relative to the computing device described above. The computing device may also be connected to one or more data stores that are affected by the operation of the integration module 108 or refill request processing module 102.

The network connections depicted in FIG. 1 may include a local area network (LAN) and a wide area network (WAN), but may also include other networks. When used in a LAN networking environment, the computing devices are connected to the LAN through a network interface or adapter. When used in a WAN networking environment, the computing devices may include a modem or other means for establishing communications over the WAN, such as the Internet. It will be appreciated that the network connections shown are illustrative and other means of establishing a communications link between the computers may be used. The existence of any of various well-known protocols such as TCP/IP, Ethernet, FTP, HTTP and the like is presumed.

Referring now to FIG. 2, a flowchart of example method steps for automatically processing refill requests is shown. The refill request processing procedure may begin when a refill request is received (step 202). A health care provider may receive the refill request at an inbox or task list of an EMR system, and the EMR system may forward the refill request to an integration module 108 in FIG. 1) of the refill request processing system 100 in FIG. 1). The refill request may include information relating to the patient, medication, health care provider, and any other information that may be necessary to fulfill the refill request. For example, the refill request may specify the name of the patient, the name of the health care provider, and the name of the medication requested.

A health care provider may receive refill requests from different EMR systems in a variety of different formats including, for example, structured formats, unstructured formats, or proprietary formats such as the eRenewal format utilized by SureScripts. The health care provider may also receive refill requests via phone, fax, or email also in a structured or unstructured format. The refill request may also be manually created by the health care provider and thus be referred to as a manual refill request. The refill request processing system is configured to identify or determine how a refill request is formatted and determine how to process the refill request based on the determined format. As discussed further below, the refill request processing system may automatically process and authorize the refill request if the system can extract certain refill information from the refill request. If, however, the refill request processing system cannot such information, then the refill request processing system may notify and task an individual (e.g., a doctor, nurse, or other health care provider) to review the refill request and, in some circumstances, provide the system with a new type of refill request that is formatted such that the refill information is accessible to the system.

A structured refill request may specify the refill information as fields with corresponding values, e.g., key-value pairs. An unstructured refill request may include the refill information as raw text data in a flat text file. In either case, the refill request processing system may parse the refill request (step 204) to extract the refill information. For structured refill requests, the refill request processing module (102 in FIG. 1) may be configured to parse the refill information from the refill request using an appropriate parser. For unstructured requests, an integration module may be configured to employ a text matching algorithm to extract the refill information from the raw text.

Additionally, because different EMR systems may format refill requests differently, the refill request processing system may include multiple integration modules each respectively configured to parse refill information from refill requests received from a particular EMR systems. In this regard, the integration modules may be understood as custom adapters designed to process refill requests from a particular source. For example, some EMR systems may permit health care providers to include free-form text (e.g., unstructured information) in the EMR. Accordingly, in some example implementations, the refill request processing system may include a processing module that employs natural language processing techniques to extract the unstructured information from the EMR. In this way, the refill request processing system may advantageously process refill requests independent of the source of the refill request.

In some example implementations, the integration modules may be configured to validate a refill request (step 206). Validating a refill request may include, for example, matching the patient identified in the refill request to an active patient of the health care provider, matching the requested medication to a list of current medications for a patient, and determining whether the medication is discontinued. Validating refill requests will be discussed further below with reference to FIG. 3. If the integration module cannot successfully validate the refill request, the integration module may provide notification to the health care provider that the refill request could not be validated. For example, the integration module may identify the provider of a patient mismatch, a medication mismatch, or a discontinued medication. If the refill request processing system successfully validates the refill request, then the refill request processing system may continue processing the refill request.

As noted above, the integration modules may be custom adapters configured and designed to parse or extract refill information from refill requests. Having obtained the refill information from the refill request, the integration module may normalize the refill information (step 208) to obtain normalized refill information that the refill request processing module uses to determine whether to authorize the refill request. In some example implementations, the integration modules may normalize refill information by generating a JSON object (JavaScript Object Notation) containing the refill information. In this regard, the integration modules may be understood as converting or transforming the variously formatted refill requests into a commonly formatted refill request, e.g., a JSON object. The refill request processing module may be configured to parse the JSON object containing the refill information in order to further process the refill request.

The refill request processing module, in this example, determines whether to authorize or not authorize a refill request. The refill request processing module determines whether to authorize a refill request by determining whether one or more refill protocols are satisfied. Accordingly, the refill request processing module may obtain a set of one or more refill protocols (step 210) from a protocol repository such as the refill protocol repository of FIG. 1 and apply the refill protocol to the refill request (step 212).

Refill protocols may specify policies, procedures, standards, or recommendations that should be followed when authorizing a refill request. For example, a refill protocol may specify that the patient must consult with the health care provider before the refill request can be authorized. In this example, the refill request processing module may determine whether the patient has consulted with the health care provider when determining whether to authorize the refill request. As another example, the refill protocol may specify particular health criteria that the patient must satisfy before the refill request can be authorized. The refill request processing module may, in this example, examine the health records of the patient (e.g., lab test results) to determine whether the patient satisfies the health criteria. It will be understood that the refill protocols may specify additional or alternative criteria used to indicate whether a refill request can be authorized. Refill protocols may be regulatory protocols, organizational protocols, or protocols unique to the health care provider. It will be appreciated that the refill protocols may specify additional or alternative information associated with the refill request, the patient, the medical history for the patient, and other information provided in the EMR for a patient. For example, a refill protocol may specify that patient DNA information should be analyzed to identify potential drug-gene interactions. The refill request processing module may obtain the patient DNA information from the EMR for the patient and compare it to the drug information for the drug identified in the refill request. Accordingly, the protocol repository in FIG. 1 may include multiple refill protocols respectively associated with multiple health care providers. Additionally or alternatively, the refill request processing module may be in signal communication with multiple protocol repositories that store one or more refill protocols.

The refill request processing module may determine which health care provider the refill request is associated with and querying the protocol repository for the refill protocols associated with that health care provider. Having obtained the refill protocol for the health care provider, the refill request processing module may apply or compare the refill information in the refill request to the refill protocol.

As a result of the application of the refill protocol, the refill request processing module, in this example, may make one of three decisions. The refill request processing module may determine that the protocol is satisfied in which case the refill request processing module might authorize the refill request. The refill request processing module may determine that the protocol is not satisfied in which case the refill request processing module determines not to authorize the refill request. The refill request processing module may alternatively determine that the refill information is insufficient, and that the refill request may be authorized if supplemental information were available.

As seen in FIG. 2, if the refill request processing module determines that the refill information is insufficient (step 214), then the refill request processing module may set a timeout period (step 216) and notify the health care provider that supplemental information is needed (step 218). The refill request processing module may forward a message back to the integration module, which may in turn forward the message to the EMR system utilized by the health care provider. The message requesting supplemental information may thus appear in the inbox or task list for the health care provider at the EMR system.

Having requested the supplemental information from the health care provider, the refill request processing module may wait for the supplemental information to become available (step 220). The refill request processing module may wait for the supplemental information for the duration of the timeout period. If the timeout period has not expired (step 222), the refill request processing module may continue to wait for the supplemental information (step 220).

As an example, the refill protocol may specify a set of health criteria the patient must satisfy in order to authorize the refill request. The requisite health information may be found in a set of lab test results for the patient. The lab test results may be stored at the EMR system such that the health information is inaccessible to the refill request processing module, e.g., in a PDF file. The refill request processing module may forward a message via the integration module to the EMR system indicating the supplemental information is needed to continue processing the refill request. Having received the message indicating that the refill request processing module seeks the supplemental information, the health care provider may review the lab test results, and add the information from the lab test results to the EMR system such that the information is available to the refill request processing module. Once the supplemental information is available to the refill request processing module, the refill request processing module may continue processing the refill request to determine if the protocol is satisfied.

If the timeout period expires (step 222) before the refill request processing module receives the supplemental information or before the supplemental information is otherwise available to the refill request processing module, then the refill request processing module may send the refill request to a review pool for review by the health care provider (step 224). As noted above, the review pool may represent a list of refill requests the refill request processing module could not authorize for various reasons. A health care provider may then review the review pool to manually process refill requests that could not be automatically authorized. In this example, the review pool may include refill requests for which supplemental information was needed but not provided before the timeout period expired.

In this way, the refill request processing system advantageously routes messages and refill requests to the particular health care providers for which they are best suited. A nurse or assistant may be better suited to respond to situations where supplemental information is not available to the refill request processing module, and a doctor may be better suited for situations where refill requests fail to satisfy a refill protocol. Accordingly, the refill request processing module automatically authorizes refill requests whenever possible and solicits the involvement of different health care providers when their input is needed thereby improving the efficiency of responding to refill requests.

Referring back to FIG. 2, if the supplemental information is received at the refill request processing module or becomes otherwise available before the timeout period expires (step 226), then the refill request processing module may decide to continue processing the refill request. Having the necessary information, the refill request processing module may determine whether the refill protocols are satisfied (step 228). If the refill request does not satisfy the refill protocols, then the refill request processing module may decide not to authorize the refill request and provide notification the refill request was not authorized (step 230). The refill request processing module may forward a message back to the EMR system via the integration module indicating the refill protocols were not satisfied. The message that the refill request did not satisfy the refill protocols may thus appear in the inbox or task list for the health care provider at the EMR system. The refill request processing module may also send the refill request to a review pool that includes refill requests that did not satisfy the refill protocols as noted above.

If the refill request does satisfy the refill protocols (step 228), then the refill request processing module may check to ensure that the refill request is not a duplicate refill request (step 232). The refill request processing module may determine whether the refill request is a duplicate refill request based, at least in part, on the refill information, e.g., the patent information, provider information, and medication information.

If the refill request is a duplicate refill request (step 234), then the refill request processing module may not authorize the refill request. The refill request processing module may forward a message back to EMR system via the integration module indicating the refill request is a duplicate refill request. The message that the refill request is a duplicate refill request may thus appear in the inbox or task list for the health care provider at the EMR system. The refill request processing module may also send the refill request to a review pool that includes duplicate refill requests. A health care provider, e.g., a nurse, may inspect the review pool and take appropriate action with respect to the duplicate refill requests. For example, the health care provider may contact the patient associated with the duplicate refill request or simply discard the duplicate refill request. In some example implementations, the refill request processing system may automatically discard the duplicate refill request instead of sending the duplicate refill request to the review pool.

If the refill request is not a duplicate refill request (step 234), then the refill request processing module may authorize fulfillment of the refill request and determine the authorization information for the refill (step 236). Authorization information for the refill may include, for example, the duration of the refill, refill instructions, and the like. The authorization information may be specified, for example, by the refill protocols. The refill request processing module may provide notification that the refill request is authorized (step 238). The refill request processing module may, for example, forward a message back to the EMR system via the integration module indicating that the refill request is authorized. The message may include the authorization information. The health care provider may review the authorization message and then transmit the refill authorization with the authorization information to a pharmacy for fulfillment (step 240). In some example implementations, the refill request processing module may, transmit the message to the integration module, which may prepare the authorization order based on the message provided by the refill processing module.

Once the refill request authorized, the refill request processing module may wrap up the authorization process by performing various post-authorization tasks (step 242). As an example, the refill request processing module or the integration module may instruct the EMR system to automatically schedule a follow-up appointment for the patient when the authorized refill is due to expire. As another example, the refill request processing module may forward a message via the integration module to the EMR system requesting that the health care provider review the authorized refill request. The refill request processing system may perform additional or alternative types of post-authorization tasks. Other types of post-authorization tasks may include, for example, care gap analysis activities. Care gap analysis refers to a review of the medical records for a patient to determine whether any further visits, follow-ups, tests, procedures, or other medical activities are recommended. Care gap recommendations may be based, for example, on provider protocols, organizational protocols, or governmental protocols. As an example, a provider protocol may specify that a physical is recommended at least once a year for patients over seventy years old. The care gap analysis may indicate that a patient has not been seen for a physical in over a year, and the refill request processing system may automatically create a message or other notification for the patient EMR recommending the patient schedule the physical. It will be appreciated that the care gap analysis may recommend additional or alternative health services according to the protocols, e.g., mammograms, prostate exams, colonoscopies, blood work, eye exams, and the like.

As noted above, the integration module may validate refill requests having an unstructured or proprietary format. FIG. 3 is a flowchart 301 of example method steps for validating refill requests. As noted above the integration module may parse the refill request to extract the refill information including the patient information and medication information (step 300). The integration module may then attempt to match the patient information to an active patient for the health care provider (step 302). If the integration module cannot match the patient (step 304), then the integration module may decide not to validate the refill request and create a new manual refill request (step 306), which may be received at the inbox or task list of the health care provider (step 202 in FIG. 2). The health care provider may then manually match the refill request to a patient such that the manual refill request appropriately identifies the patient. The health care provider may forward the updated refill request back to the refill request processing system for authorization. If the health care provider cannot manually match the patient, then the health care provider may, for example, discard the refill request. In other words, the refill request processing system may notify an individual when the system cannot extract or otherwise access refill information in a refill request, e.g., the patient name or the medication name. The individual may update the refill request to include the refill information (or provide a new refill request) and resubmit the updated refill request to the system so processing can continue.

If the integration module successfully matches the patient associated with the refill request (step 304), then the integration module may attempt to match the requested medication to a current medication for the patient. The integration module may obtain a current list of medication for the patient (step 308), e.g., from the EMR associated with the patient at the EMR system. If the requested medication matches a medication listed on the current list of medications for the patient (step 310), then the integration module may decide to validate the refill request (step 312).

If the integration module cannot match the requested medication to a current medication for the patient (step 310), then the integration module may determine if the requested medication is a discontinued medication. The integration module may compare the requested medication to a list of discontinued medications (step 314). If the requested medication is a discontinued medication (step 316), then the integration module may decide not to validate the refill request (step 318) and forward the refill request to a review pool that includes refill requests for discontinued medications (step 320). A health care provider may inspect the review pool in order to determine alternative medications for the refill requests. Once the health care provider determines an alternative medication, the health care provider may issue a new prescription for the alternative medication, or update the refill request to indicate the alternative medication and forward the updated refill request back to the refill request processing system for authorization.

If the integration module determines that the requested medication is not discontinued (step 316), then the refill request may be requesting a medication that is not currently prescribed to the patient. Accordingly, the integration module may decide not to validate the refill request (step 322). The integration module may also forward the refill request to a review pool that includes refill requests that were denied validation (step 324) and create a new manual refill request (step 306). The manual refill request may be received at the inbox or task list of the health care provider (step 202 in FIG. 2) such that the health care provider may manually match the requested medication. The health care provider may also inspect the review pool of invalidated refill requests to determine why the integration module could not validate the refill request.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

What is claimed is:

1. A computer-implemented method of processing medication refill requests comprising:
receiving a medication refill request;
parsing the refill request to obtain refill information contained in the refill request;
determining whether to authorize the refill request based, at least in part, on the refill information;
wherein determining whether to authorize the refill request includes determining whether supplemental information used to authorize the refill request is available; and
in response to a determination that the supplemental information is not available,
providing a notification that the supplemental information is not available,
setting a timeout period,
deciding to continue processing the refill request when the supplemental information becomes available before the timeout period expires, and
discarding the refill request when the timeout period expires before the supplemental information becomes available.

2. The computer-implemented method of claim 1 wherein discarding the refill request includes sending the refill request to a review pool.

3. The computer-implemented method of claim 1 wherein determining whether to authorize the refill request further includes:
validating the refill request; and
sending the refill request to a review pool when the refill request is not validated.

4. The computer-implemented method of claim 3 wherein the refill information includes patient information and validating the refill request includes:
determining whether a patient associated with the patient information is a current patient of a health care provider that received the refill request based, at least in part, on the patient information; and
deciding not to validate the refill request in response to a determination that the patient is not a current patient of the health care provider.

5. The computer-implemented method of claim 3 wherein the refill information includes requested medication information and validating the refill request includes:
determining whether a requested medication is a current medication for a patient associated with the refill request based, at least in part, on the requested medication information; and
deciding not to validate the refill request in response to a determination that the requested medication is not a current medication for the patient.

6. The computer-implemented method of claim 5 wherein validating the refill request further includes:
determining whether the requested medication is a discontinued medication; and
deciding not to validate the refill request in response to a determination that the requested medication is a discontinued medication.

7. The computer-implemented method of claim 1 wherein determining whether to authorize the refill request further includes:
determining whether the refill request is a duplicate refill request; and
sending the refill request to a review pool in response to a determination that the refill request is a duplicate refill request.

8. The computer-implemented method of claim 1 further comprising normalizing the refill information contained in the refill request to obtain normalized refill information wherein determining whether to authorize the refill is request is based, at least in part, on the normalized refill information.

9. A system for processing medication refill requests comprising:
an integration module in signal communication with an electronic medical record (EMR) system, the integration module receives a refill request from the EMR system and parses the refill request to obtain refill information contained in the refill request;
a refill request processing module in signal communication with the integration module, the refill request processing module determines whether to authorize the refill request based, at least in part, on the refill information and determines whether supplemental information used to authorize the refill request is available; and
wherein, in response to a determination that the supplemental information is not available, the refill request processing module
provides a notification that the supplemental information is not available,
sets a timeout period,
continues to process the refill request when the supplemental information becomes available before the timeout period expires, and
discards the refill request when the timeout period expires before the information becomes available.

10. The system of claim 9 further comprising at least one review pool in signal communication with at least one of the refill request processing module and the integration module wherein the at least one review pool includes one or more refill requests that could not be authorized.

11. The system of claim 10 wherein:
one of the review pools is a supplemental information review pool; and
the refill request processing module sends the refill request to the supplemental information review pool when discarding the refill request upon expiration of the timeout period.

12. The system of claim 10 wherein
one of the review pools is an invalid refill request review pool;
the integration module validates the refill request; and
the integration module sends the refill request to the invalid refill request review pool when the integration module does not validate the refill request.

13. The system of claim 10 wherein:
the refill information includes patient information;
the integration module, when validating the refill request, determines whether a patient associated with the patient information is a current patient of a health care provider that received the refill request based, at least in part, on the patient information; and
the integration module decides not to validate the refill request in response to a determination that the patient is not a current patient of the health care provider.

14. The system of claim 10 wherein:
the refill information includes requested medication information;
the integration module, when validating the refill request, determines whether a requested medication is a current medication for a patient associated with the refill request based, at least in part, on the request medication information; and
the integration module decides not to validate the refill request in response to a determination that the requested medication is not a current medication for the patient.

15. The system of claim 14 wherein:
the integration module, when validating the refill request, determines whether the requested medication is a discontinued medication; and
the integration module decides not to validate the refill request in response to a determination that the requested medication is a discontinued medication.

16. The system of claim 10 wherein:
one of the review pools is a duplicate refill request review pool;
the refill request processing module further determines whether the refill request is a duplicate refill request; and
the refill request processing module sends the refill request to the duplicate refill request review pool in response to a determination that the refill request is a duplicate refill request.

17. The system of claim 9 wherein:
the integration module normalizes the refill information contained in the refill request to obtain normalized refill information; and
the refill processing module determines whether to authorize the refill request based, at least in part, on the normalized refill information.

18. A non-transitory computer-readable storage medium having computer-executable program instructions stored thereon that when executed by a processor cause the processor to perform steps for processing medication refill requests, the steps comprising:
receiving a medication refill request;
parsing the refill request to obtain refill information contained in the refill request;
determining whether to authorize the refill request based, at least in part, on the refill information;
wherein determining whether to authorize the refill request includes determining whether supplemental information used to authorize the refill request is available; and
in response to a determination that the supplemental information is not available,
providing a notification that the supplemental information is not available,
setting a timeout period,
deciding to continue processing the refill request when the supplemental information becomes available before the timeout period expires, and
sending the refill request to a review pool when the timeout period expires before the supplemental information becomes available.

19. The computer-readable storage medium of claim 18 wherein the refill information includes patient information and requested medication information and the computer-executable program instructions, when executed by a processor, cause the processor to further perform:
validating the refill request;
sending the refill request to the review pool when the refill request is not validated; and
wherein validating the refill request includes
determining whether a patient associated with the patient information is a current patient of a health care provider that received the refill request based, at least in part, on the patient information and deciding not to validate the refill request in response to a determination that the patient is not a current patient of the health care provider,
determining whether a requested medication is a current medication for the patient based, at least in part, on the requested medication information and deciding not to validate the refill request in response to a determination that the requested medication is not a current medication for the patient, and
determining whether the requested medication is a discontinued medication and deciding not to validate the refill request in response to a determination that the requested medication is a discontinued medication

20. The computer-readable storage medium of claim 19 wherein determining whether to authorize the refill request further includes:
determining whether the refill request is a duplicate refill request; and
sending the refill request to the review pool in response to a determination that the refill request is a duplicate refill request.
